(19) United States
(12) Patent Application Publication
(10) Pub. No.: US 2009/0079566 A1
(43) Pub. Date: Mar. 26, 2009

(54) SECURITY DEVICE INCLUDING SENSOR HAVING AN EXTENSION

(75) Inventors: Mitchell Steven Goldstein, Rock Hill, SC (US); Thomas Reid Cheatham, Charlotte, NC (US)

Correspondence Address: ADAMS INTELLECTUAL PROPERTY LAW, P.A., Suite 2350 Charlotte Plaza, 201 South College Street, CHARLOTTE, NC, 28244, US

(73) Assignee: INVUE SECURITY PRODUCTS, INC., Charlotte, NC (US)

(21) Appl. No.: 12/042,789

(22) Filed: Mar. 5, 2008

Related U.S. Application Data
(60) Provisional application No. 60/974,620, filed on Sep. 24, 2007.

(51) Int. Cl. G08B 13/14

(52) U.S. Cl. 340/568.1; 340/568.2

(57) ABSTRACT

A security device for an item of merchandise having at least one removable component includes a sensor attached to the item of merchandise. The sensor has an extension that extends outwardly from the sensor in a first direction generally parallel to an axis defined by the item of merchandise sufficiently to prevent a removable component from being removed from the item of merchandise. The extension is preferably a plate having an outer surface that is adhered to the sensor and an inner surface that is adhered to the item of merchandise. The extension includes a leg depending from the plate in a second direction that defines an angle with the axis defined by the item of merchandise sufficiently to prevent a removable component from being removed from the item of merchandise when the plate is adhered to the item of merchandise. The sensor is electrically connected to an alarm circuit.

### CROSS REFERENCE TO RELATED APPLICATION

This application claims the benefit of U.S. Provisional Application No. 60/974,620, filed Sep. 24, 2007.

### BACKGROUND OF THE INVENTION

This invention relates generally to security devices for protecting items of merchandise, such as consumer electronics products. More particularly, the invention relates to a security device including a sensor having an extension configured to cover a card slot. In a particularly advantageous embodiment, the invention is a sensor for a security device configured with an extension for covering the memory card slot of a cell phone, thereby preventing theft of the memory card from a demonstration model.

It is common practice for retailers to provide demonstration models of relatively expensive consumer electronics products, for example cameras, video recorders, cassette tape players, radios, MP3 players, cell phones, etc. The demonstration model allows a potential purchaser to closely examine the product and to test the operation of its features. A working demonstration model, however, increases the possibility that the demonstration model, or a removable component thereof, such as a battery pack, battery, memory card, lens, etc., will be stolen or removed from the display area by an unauthorized person. As a result, demonstration models of consumer electronics products are typically protected by a security device that permits a potential purchaser to examine and test the product, while reducing the likelihood that the demonstration model itself, or a component of the product, will be stolen or removed from the display area by an unauthorized person.

Certain consumer electronics products are more difficult to protect than others. For example, cell phones and digital cameras are relatively small and include removable components that are easily separated from one another. Cell phones and digital cameras commonly include a battery pack (or one or more batteries) and a memory card for storing video, audio or data files. The product and each removable component must be separately secured against theft without interfering with the potential purchaser's ability to examine and test the demonstration model. This requirement typically results in the use of a security device having multiple sensors placed at different locations on the product. In addition, the product may have a moveable component, such as a sliding door or cover. Accordingly, any sensor in contact with the demonstration model must not interfere with the operation of the moveable component. Furthermore, the size and weight of any sensor placed on the demonstration model must be sufficiently small relative to the size and weight of the product.

Accordingly, there exists an unresolved need for a security device including a sensor configured for protecting a small, relatively expensive consumer electronics product including one or more removable components that are easily separated from one another. There exists a specific need for a security device including a sensor that protects a demonstration model, as well as any removable components thereof, from theft. There exists a further specific need for a security device including a sensor that prevents the theft of a demonstration model including one or more removable components, while permitting a potential purchaser to examine and test the product and without interfering with the operation of a moveable component of the product.

### BRIEF SUMMARY OF THE INVENTION

The aforementioned needs, objectives and advantages, as well as others readily apparent to those of ordinary skill in the art, are provided by a security device for an item of merchandise having at least one removable component. The security device includes a sensor attached to the item of merchandise. The sensor has an extension that extends outwardly from the sensor in a first direction defined by the item of merchandise sufficiently to prevent the removable component from being removed from the item of merchandise.

In one embodiment, the extension is a thin, elongate plate having an outer surface that is adhered to the sensor and an inner surface that is adhered to the item of merchandise. The extension extends outwardly from the sensor in a first direction that is generally parallel to an axis defined by the item of merchandise. The extension extends outwardly in the first direction sufficiently to extend beyond an edge of the item of merchandise. The extension includes a leg depending from the plate in a second direction that defines an angle with the axis defined by the item of merchandise. The leg depends from the plate in the second direction sufficiently to prevent the removable component from being removed from the item of merchandise when the plate is adhered to the item of merchandise.

In yet another embodiment, the sensor further includes a limit switch having a plunger that is biased outwardly from the sensor. The extension has an opening formed therethrough for receiving the plunger such that the plunger operably engages the item of merchandise. When the plunger is operably engaged with the item of merchandise, the sensor is in an armed state. When the plunger is disengaged from the item of merchandise, the sensor is in a disarmed state and an electrical signal is transmitted to activate an alarm circuit.

In yet another embodiment, the security device includes a first sensor electrically connected to an alarm circuit and a second sensor electrically connected to the alarm circuit. The first sensor is attached to the item of merchandise and has an extension that extends outwardly from the first sensor in a first direction defined by the item of merchandise sufficiently to prevent the removable component from being removed from the item of merchandise. The second sensor is attached to the item of merchandise and is positioned on the item of merchandise so as to permit a potential purchaser to examine and test the item of merchandise without interfering with the operation of a moveable component of the item of merchandise. The first sensor and the second sensor may be electrically connected in series with one another and the alarm circuit.

### BRIEF DESCRIPTION OF THE DRAWINGS

The present invention is best understood by reference to the following detailed description taken in conjunction with the accompanying drawing figures.

FIG. 1 is an environmental perspective view showing a security device including a sensor according to the present invention for protecting an item of merchandise having at least one removable component from theft.

FIG. 2 is an exploded perspective view of the security device of FIG. 1.

FIG. 3 is a rear perspective view showing a first sensor and a second sensor of the security device attached to an item of merchandise.

FIG. 4A is a front perspective view showing a first sensor and a second sensor of the security device attached to the item of merchandise with a moveable component in a closed configuration.

FIG. 4B is a side view of the security device and the item of merchandise of FIG. 4A.

FIG. 5A is a front perspective view showing the first sensor and the second sensor of the security device attached to the item of merchandise with the moveable component in an opened configuration.

FIG. 5B is a side view of the security device and the item of merchandise of FIG. 5A.

FIG. 6 is a side view showing the first sensor of the security device being separated from the item of merchandise and with the first sensor in a disarmed state.

### DETAILED DESCRIPTION OF THE INVENTION

Referring to the accompanying drawing figures wherein identical reference numerals denote the same elements throughout the various views, a security device according to the present invention is indicated generally at 10. The security device 10 is operable for protecting an item of merchandise, such as a consumer electronics product, indicated generally at 50. More particularly, the security device 10 is operable for protecting a relatively small, relatively expensive consumer electronics product 50, for example a camera, video recorder, cassette tape player, radio, MP3 player, cell phone, etc., having at least one removable component, for example a battery pack, battery, memory card, lens, etc. The item of merchandise 50 may be any product having at least one removable component. By way of example and without limitation, the item of merchandise 50 shown and described herein is a demonstration model of a conventional cellular telephone mobile handset, commonly referred to as a “cell phone.” A cell phone 50 of the type suitable for use with the security device 10 of the present invention is the ROKR candy bar style phone available from Motorola, Inc. of Schaumberg, Ill., USA. The demonstration model is typically provided by a retailer in a display area for potential purchasers to closely examine and test the operation of various features of the cell phone 50. The security device 10 permits a potential purchaser to examine and test the cell phone 50, while reducing the likelihood that the demonstration model, or a removable component of the cell phone 50, will be stolen or removed from the display area by an unauthorized person.

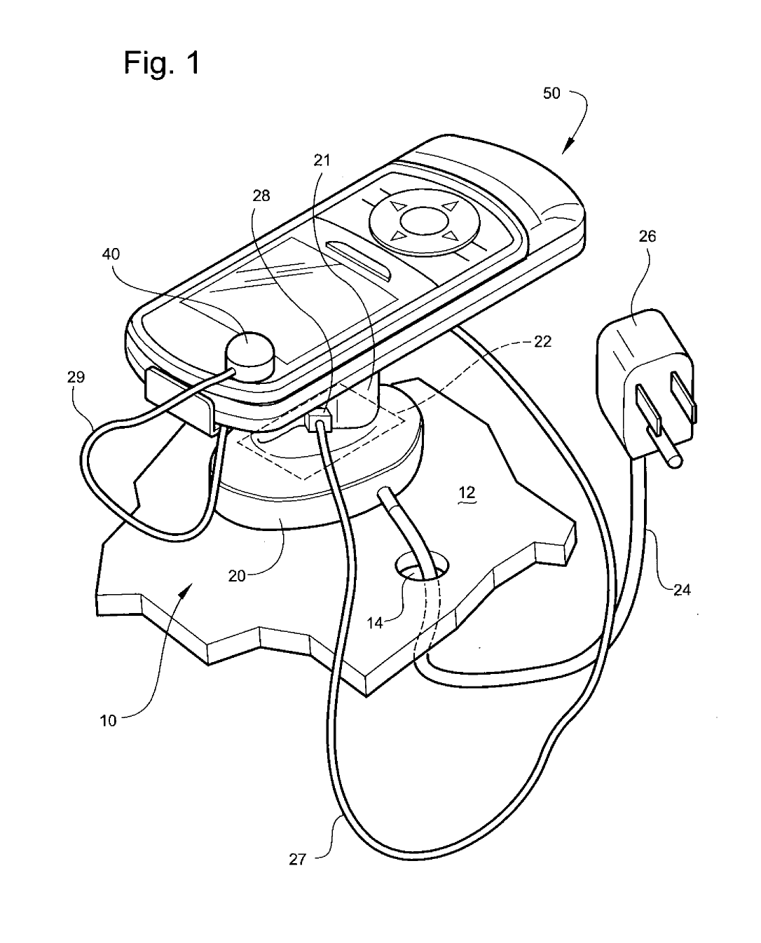

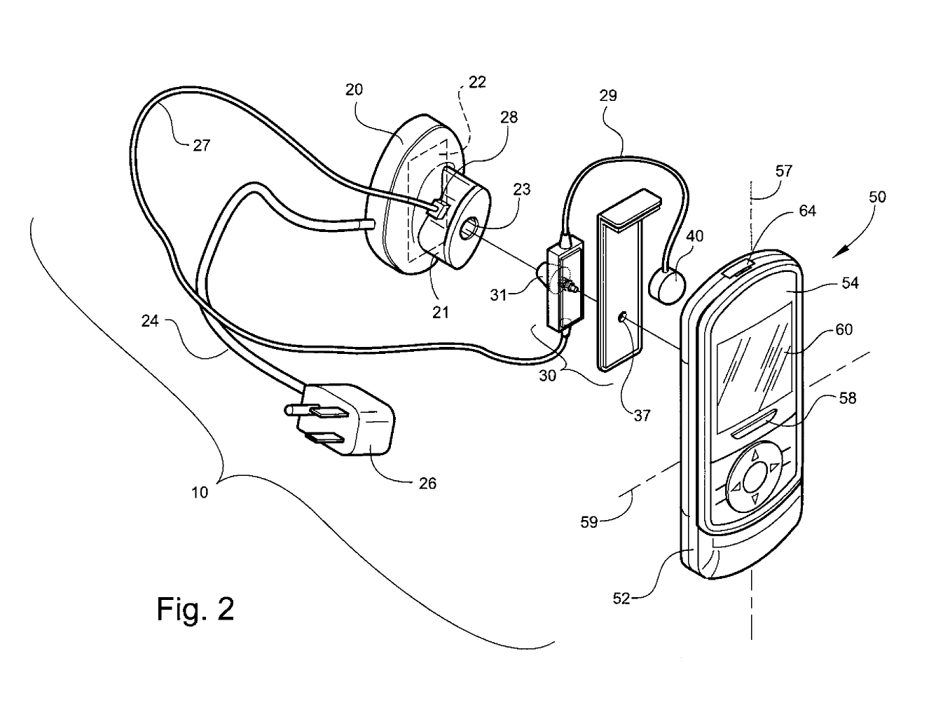

As shown in FIGS. 1 and 2, the security device 10 comprises a base 20, a printed circuit board (PCB) 22 disposed within the base, and a power cord 24 electrically connected to the PCB and having a plug 26 for supplying power to the PCB. The plug 26 may, for example, be an AC/DC adapter plug for supplying DC voltage to the PCB 22 from an AC power source, such as a conventional electrical outlet. The security device further comprises a first sensor cable 27 electrically connected to the PCB 22 and extending between the base 20 and a first sensor 30 (FIG. 2) configured to be attached to the cell phone 12 in a manner to be described hereinafter. The security device 10 may further comprise an optional second sensor cable 29 extending between the first sensor 30 and an optional second sensor 40 configured to be likewise attached to the cell phone 50 for a purpose to be described hereinafter. The second sensor 40 may be electrically connected in series arrangement with the first sensor 30 and the PCB 22, as shown. Alternatively, the second sensor 40 may be electrically connected in series arrangement directly with the PCB 22. In the latter instance, the second sensor cable 29 may be combined within a single sheath with the first sensor cable 27 between the base 20 and a “Y” branch located medially between the base and the first sensor 30. Regardless, the first sensor cable 27 may comprise a connector 28 disposed at one end for connecting the first sensor 30 and the optional second sensor 40 to the base 20.

The base 20 has a pedestal portion 21 that houses a magnet (not shown) for cooperating with a magnet having an opposite potential disposed within a conical portion 31 (FIG. 2) of the first sensor 30. The magnets cooperate to releasably position the conical portion 31 of the first sensor 30 within a corresponding conical recess 23 (FIG. 2) formed in the pedestal 21 with the cell phone 50 in a predetermined display orientation. In this manner, a potential purchaser may remove the cell phone 50 from the base 20 of the security device 10 temporarily to examine and test its features. When returned to the base 20, the magnets automatically align the cell phone 50 in the predetermined display orientation. The base 20 is typically secured to a support surface 12 (FIG. 1), such as a table, desk, wall, etc., having a relatively small opening 14 (FIG. 1) formed therethrough for routing the power cord 24 to the power source, such as a conventional electrical outlet. In this manner, the base 20 cannot be easily removed from the support surface 12 and the power cord 24 cannot be easily unplugged from the power source in an attempt to disable and remove the security device 10.

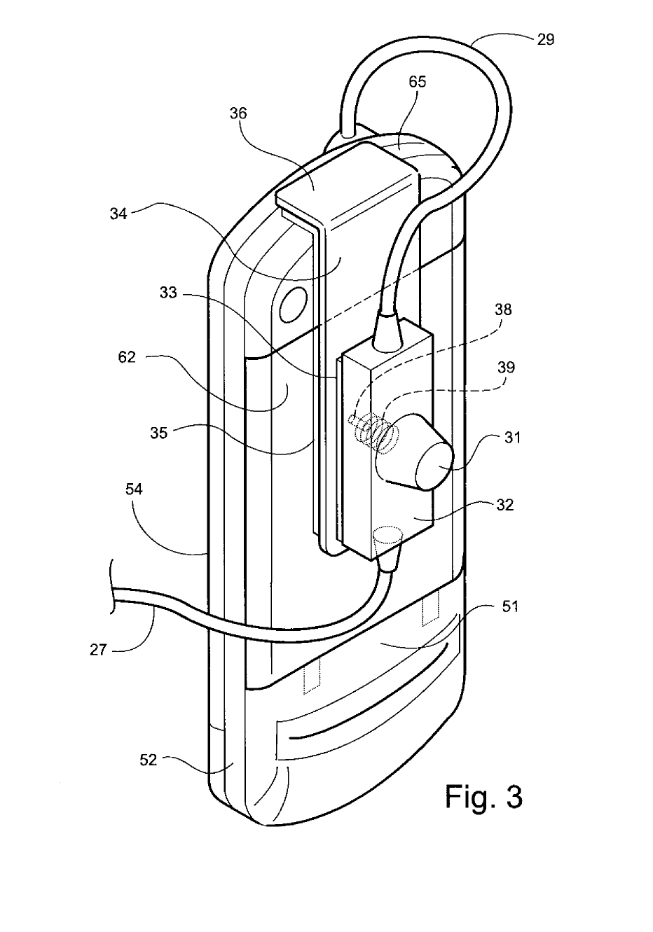

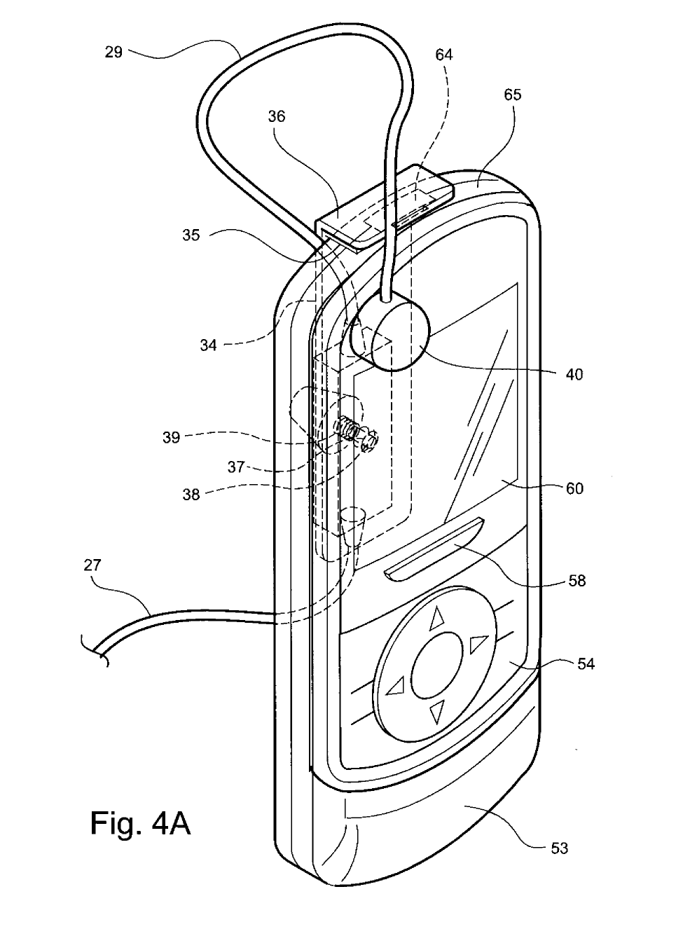

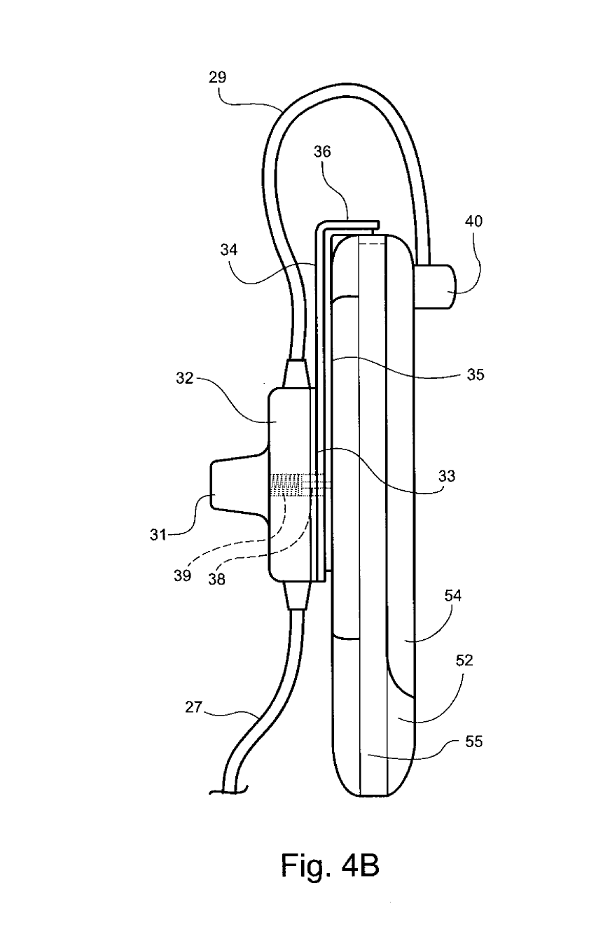

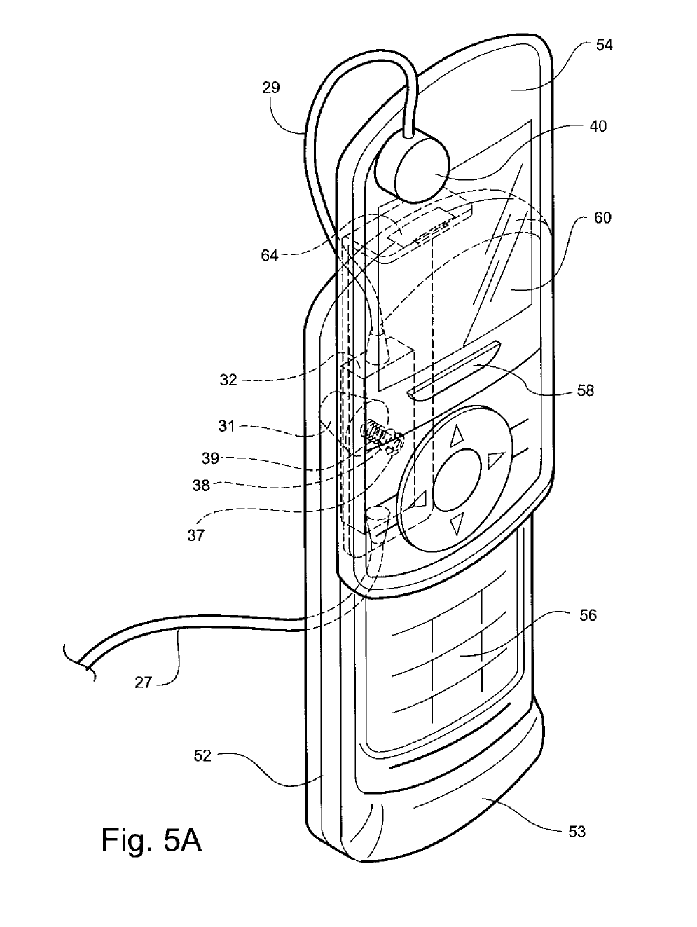

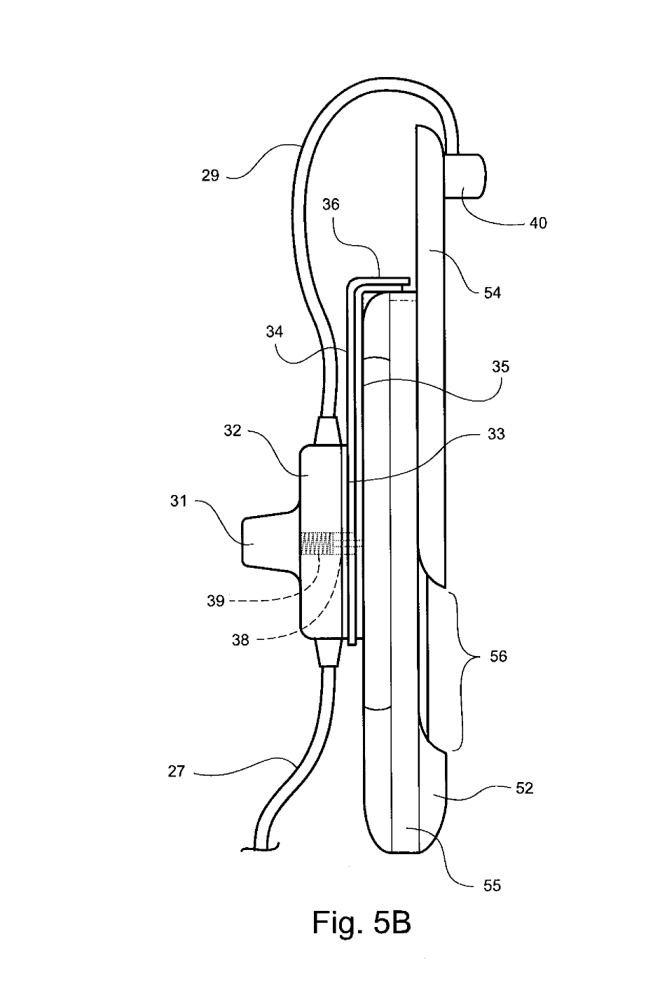

As previously mentioned, the first sensor 30 and the optional second sensor 40 are attached to the cell phone 50. FIGS. 3, 4A and 4B show the first sensor 30 and the second sensor 40 attached to the cell phone 50 with a moveable component of the cell phone in a closed configuration. In particular, FIG. 3 is a perspective view of the rear 51 of the cell phone 50 in the closed configuration, while FIG. 4A is a perspective view of the front 53 of the cell phone 50 in the closed configuration. FIG. 4B is a side view showing one side 55 of the cell phone 50 in the closed configuration, the opposite side being essentially the same in all relevant aspects. FIGS. 5A and 5B show the first sensor 30 and the second sensor 40 attached to the cell phone 50 with the moveable component of the cell phone in an opened configuration. In particular, FIG. 5A is a perspective view of the front 53 of the cell phone 50 in the opened configuration. FIG. 5B is a side view showing one side 55 of the cell phone 50 in the opened configuration, the opposite side being essentially the same in all relevant aspects.

The cell phone 50 comprises a body 52 and a moveable access cover 54 for accessing control buttons or keys 56, for example an alphanumeric keypad for operating various features of the cell phone 50. As shown, the access cover 54 comprises a finger pad or grip 58 for moving the cover between the closed configuration and the opened configuration. The access cover 54 may also have a transparent window 60 for viewing a display screen (not shown) provided on the front face of the body 52. The body 52 of the cell phone 50 is relatively thin and defines a longitudinal (lengthwise) axis 57 and a transverse (widthwise) axis 59 in the plane of the body 52 that is generally perpendicular to the longitudinal axis. In the exemplary embodiments shown and described herein, the access cover 54 is moveable in the direction of the longitudinal axis 57 between the closed configuration and the opened configuration. As shown, the access cover 54 is slideable relative to the body 52 in the direction of the longitudinal axis 57. However, if desired, the access cover 54 may be hinged about an axis parallel to the longitudinal axis 57 or the transverse axis 59, or alternatively, may be removable from and replaceable onto the body 52 in a conventional manner.

The cell phone 50 further has at least one removable component. In particular, the cell phone 50 has one or more removable batteries (not shown) housed within the body 52 behind a battery compartment door 62 (FIG. 3). In normal operation, the battery compartment door 62 may be opened or removed entirely to access the battery or batteries. Alternatively, the battery compartment door 62 and the battery or batteries may be configured as an integral unit commonly referred to as a “battery pack.” Regardless, the battery, batteries or battery pack may be removed by opening or removing the battery compartment door 62. Accordingly, the security device 10 is operable, as will be described, to prevent theft or removal of the battery, batteries or battery pack from the cell phone 50 by an unauthorized person.

The cell phone 50 further comprises a removable memory card (not shown) that is housed within an opening 64 formed in the body 52 of the cell phone 50. The opening 64 is commonly referred to as a “card slot” and receives a removable memory card, chip, diskette, etc. having electronic audio, video and/or data files. However, the opening 64 may receive any removable component of the cell phone 50 now known or known hereinafter without departing from the spirit and scope of the present invention. In the exemplary embodiments shown and described herein, a card slot 64 is formed in the body 52 on an end 65 of the cell phone 50. Alternatively, the card slot 64 may be formed in the body 52 on either side 55 of the cell phone 50, or may be formed in the body 52 on the rear 51 of the cell phone 50. Regardless, the card slot 64 is sized and shaped to receive the removable memory card. Accordingly, the security device 10 is operable, as will be described, to prevent theft or removal of the memory card from the cell phone 50 by an unauthorized person.

The first sensor 30 comprises a body 32 having an extension 34 that extends outwardly from the body 32 in a first direction generally parallel to the longitudinal axis 57 defined by the cell phone 50. The extension 34 extends from the body 32 sufficiently to prevent a removable component from being removed from the cell phone 50. In particular, the extension 34 extends outwardly from the body 32 sufficiently to overlie at least a portion of the battery compartment door 62 and the body 52 on the rear 51 of the cell phone 50. In the embodiment shown, the extension 34 is a relatively thin, elongate plate having an inner surface adjacent the rear 51 of the cell phone 50 and an outer surface, at least a portion of which is adjacent the first sensor 30. The body 32 of the first sensor 30 is secured to the outer surface of the elongate plate. The first sensor 30 may be secured to the extension 34 in any suitable manner, but preferably, is secured by a relatively thin adhesive layer 33. In turn, the inner surface of the elongate plate is secured to at least a portion of the battery compartment door 62 and at least a portion of the body 52 on the rear 51 of the cell phone 50. The extension 34 may be secured to the battery compartment door 62 and to the body 52 in any suitable manner, but preferably, is secured by a relatively thin adhesive layer 35. As a result, the battery compartment door 62 (or in other instances, the battery pack) cannot be opened or removed from the cell phone 50 without separating the extension 34 from the body 52 on the rear 51 of the cell phone. Consequently, the extension 34 prevents the theft or removal of the battery, batteries or battery pack from the cell phone 50 by an unauthorized person.

The extension 34 of the first sensor 30 may further comprise a leg 36 depending from the elongate plate in a second direction that defines an angle with the longitudinal axis 51 defined by the cell phone 50. In the exemplary embodiments shown and described herein, the second direction is generally perpendicular to the longitudinal axis 57 (and to the first direction), and thus, is generally parallel to the transverse axis 59 defined by the cell phone 50. The leg 36 depends from the elongate plate in the second direction sufficiently to prevent a removable component from being removed from the cell phone 50. In particular, the leg 36 depends from the elongate plate sufficiently to overlie at least a portion of the card slot 64 on the end 65 of the cell phone 50. In the embodiment shown, the leg 36 is a relatively thin, elongate plate having an inner surface adjacent the end 65 of the cell phone 50. As shown, the leg 36 is integral with the extension 34 and may be formed by bending (e.g. metal material) or molding (e.g. plastic material) a suitable length of the extension at the end of the elongate plate opposite the first sensor 30. If required, due to the gauge and bending strength of the material of the extension 34, the inner surface of the leg 36 may be secured to the end to the body 52 on the end 65 of the cell phone 50. The leg 36 may be secured to the body 52 in any suitable manner, but preferably, is secured by the relatively thin adhesive layer 35 in the same manner as the extension 34 is adhered to the battery compartment door 62 and the body 52 on the rear 51 of the cell phone 50. As a result, the memory card stored within the card slot 64 formed in the body 52 cannot be removed from the cell phone 50 without separating the extension 34, including the leg 36, from the body 52 on the rear 51 and the end 65 of the cell phone. Consequently, the extension 34, and more specifically the leg 36, prevents the theft or removal of the memory card from the cell phone 50 by an unauthorized person.

It should be noted that the leg 36 of the extension 34 is sized and positioned to overlie at least a portion of the card slot 64 without interfering with the operation of the cell phone 50. In particular, the leg 36 does not prevent or interfere with movement of the access cover 54 of the cell phone 50 from the closed configuration to the opened configuration. As a result, a potential purchaser may closely examine and fully test all of the operating features of the cell phone 50. It should also be noted that in certain instances the card slot 64 may be formed in the body 52 on the side 55 of the cell phone 50. In such instances, the leg 36 is configured to depend from the elongate plate sufficiently to overlie at least a portion of the corresponding side 55 of the cell phone 50. In other instances, the card slot 64 may be formed on the body 52 on the front 53 of the cell phone 50. In such instances, the leg 36 is configured to depend from the elongate plate sufficiently to overlie at least a portion of the front 53 of the cell phone 50. The leg 36 may take any form, and have any shape and/or size (length and width) necessary to overlie at least a portion of the card slot 64 regardless of its location on the body 52 of the cell phone 50.

As shown and described herein, the security device 10 comprises a first sensor 30 and a second sensor 40 mechanically connected together in a series arrangement with the base 20. In particular, the first sensor 30 is mechanically connected to the base 20 by the first sensor cable 27, and the second sensor 40 is mechanically connected to the first sensor 30 by the second sensor cable 29. The first sensor cable 27 extends into the base 20 to electrically connect the first sensor 30 and the second sensor 40 to the PCB 22 disposed within the base. The first sensor 30 and the second sensor 40 may be any suitable device for sensing separation of the cell phone 50 and the sensor, or an interruption in electrical conduction between the sensor and the PCB 22, and upon sensing either condition, generating and transmitting an electrical signal to activate an alarm circuit disposed on the PCB. Such devices are well known to those skilled in the art and need not be described in greater detail with regard to the present invention.

In the exemplary embodiments shown and described herein, the first sensor 30 includes a limit switch comprising a plunger 38 that is biased outwardly from the body 32 of the first sensor by a conventional coil spring 39. The first sensor 30 defines an armed stated when the plunger 38 is depressed and a disarmed state when the plunger is extended by the biasing force of the spring 39. More particularly, the first sensor 30 is in the armed state when the body 32 is secured to the cell phone 50 and is in the disarmed state when the body 32 is separated from the cell phone. The second sensor 40 may be configured with a limit switch in the same manner, or may be an entirely different type of sensor as long as the alarm circuit is activated under the aforementioned conditions. When the first sensor 30 is used in conjunction with the extension 34 as previously described, an opening 37 (FIG. 2; FIG. 4A; FIG. 5A) is formed through the elongate plate of the extension to permit the plunger 38 to operably engage the battery compartment door 62 or the body 52 on the rear 51 of the cell phone 50.

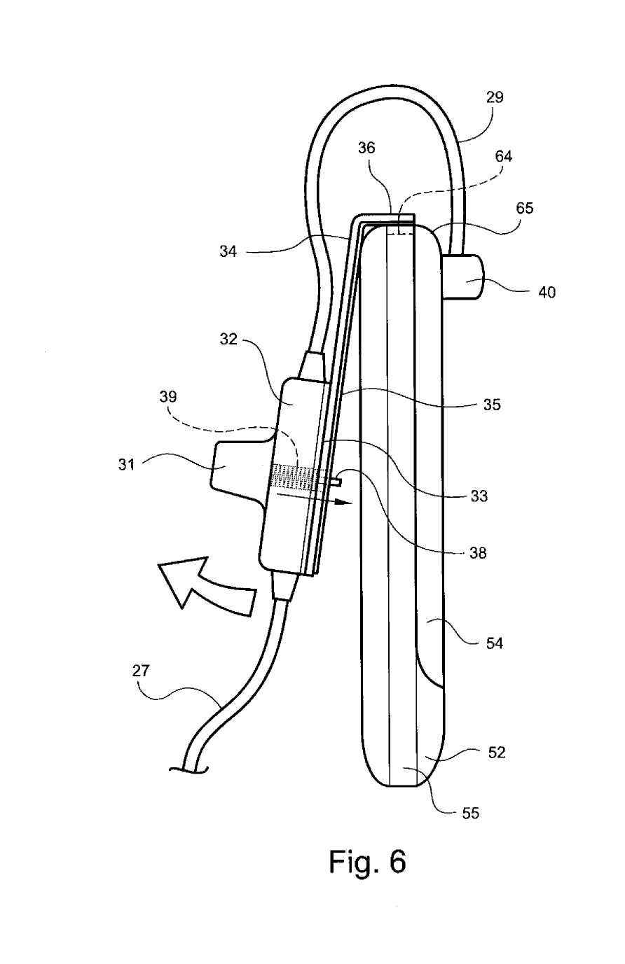

FIG. 6 is a side view showing the first sensor 30 of the security device 10 being separated from the cell phone 50 and with the first sensor in the disarmed state. It should be noted that the first sensor 30 can be separated from the cell phone 50 by overcoming the adhesion force of the adhesive layer 33 between the first sensor and the outer surface of the extension 34. Alternatively, the first sensor 30 can be separated from the cell phone 50 as illustrated in FIG. 6 by overcoming the adhesion force of the adhesive layer 35 between the inner surface of the extension 34 and the battery compartment door 62, body 52 on the rear 51 of the cell phone, and if present, the body 52 on the end 65 of the cell phone. In either instance, however, the plunger 38 is biased outwardly by the spring 39 and extended such that the first sensor 30 is in the disarmed state. As a result, the first sensor 30 generates and transmits an electrical signal to activate the alarm circuit disposed on the PCB 22. Separating the extension 34 of the first sensor 30 from the cell phone 50 as described above is necessary in order to remove the battery, batteries or battery pack disposed within the body 52 of the cell phone, or to remove the memory card disposed within the card slot 64 formed in the body 52 of the cell phone. Accordingly, the first sensor 30 having the extension 34 is effective to prevent the theft or removal of a removable component of a cell phone 50 by an unauthorized person, while permitting a potential purchaser to examine and test the cell phone and without interfering with the operation of a moveable component, such as access cover 54.

The foregoing has described one or more exemplary embodiments of a security device for an item of merchandise including a sensor having an extension for preventing the theft or removal of at least one removable component of the item of merchandise. While particular exemplary embodiments of the present invention have been described, it will be apparent to those skilled in the art that various modifications thereto can be made without departing from the spirit and scope of the invention. Accordingly, the foregoing description of the preferred embodiments of the invention and the best mode for practicing the invention are provided for the purpose of illustration only, and not for the purpose of limitation. In particular, it will be appreciated that a security device including a sensor having an extension in accordance with the present invention may be applicable for use with various items of merchandise, including but not limited to consumer electronic products, now known or hereinafter devised, without departing from the spirit and scope of any appended claim.

That which is claimed is:

1. A security device for an item of merchandise having at least one removable component, comprising:
a sensor attached to the item of merchandise; and
an extension that extends outwardly from the sensor sufficiently to prevent the at least one removable component from being removed from the item of merchandise, the extension having an outer surface that is adhered to the sensor and an inner surface that is adhered to the item of merchandise.

2. A security device according to claim 1, wherein the extension extends outwardly from the sensor in a first direction that is generally parallel to an axis defined by the item of merchandise.

3. A security device according to claim 2, wherein the extension extends outwardly in the first direction sufficiently to extend beyond an edge of the item of merchandise.

4. A security device according to claim 3, wherein the extension comprises a relatively thin, elongate plate and a leg depending from the plate in a second direction that defines an angle with the axis defined by the item of merchandise.

5. A security device according to claim 4, wherein the leg depends from the plate in the second direction sufficiently to prevent the at least one removable component from being removed from the item of merchandise when the inner surface of the extension is adhered to the item of merchandise.

6. A security device according to claim 1, wherein the sensor comprises a limit switch having a plunger that is biased outwardly from the sensor and wherein the extension has an opening formed therethrough for receiving the plunger such that the plunger operably engages the item of merchandise.

7. A security device according to claim 6, wherein the sensor is in an armed state when the plunger is operably engaged with the item of merchandise and is in a disarmed state when the plunger is operably disengaged from the item of merchandise, and wherein an electrical signal is transmitted to activate an alarm circuit when the sensor is in the disarmed state.

8. A security device for an item of merchandise having at least one removable component, comprising:
an alarm circuit;
a first sensor electrically connected to the alarm circuit; and
a second sensor electrically connected to the alarm circuit;
wherein the first sensor is attached to the item of merchandise and has an extension that extends outwardly sufficiently to prevent the removable component from being removed from the item of merchandise.

9. A security device according to claim 8, wherein the second sensor is attached to the item of merchandise and is positioned thereon so as to permit a potential purchaser to examine and test the item of merchandise without interfering with the operation of a moveable component of the item of merchandise.

10. A security device according to claim 8, wherein the first sensor and the second sensor are electrically connected in series with one another and with the alarm circuit.

11. A security device according to claim 8, further comprising a base and wherein the alarm circuit is disposed within the base.

12. A security device according to claim 11, wherein the base houses a first magnet for cooperating with a second magnet having an opposite potential disposed within the first sensor, the first magnet and the second magnet cooperating to releasably position the first sensor on the base with the item of merchandise positioned in a predetermined display orientation.

13. A security device according to claim 11, further comprising a first sensor cable for mechanically connecting the first sensor to the base and a second sensor cable for mechanically attaching the second sensor to the first sensor.

14. A security device according to claim 8, wherein the extension extends outwardly from the first sensor in a first direction that is generally parallel to an axis defined by the item of merchandise and extends outwardly in the first direction sufficiently to extend beyond an edge of the item of merchandise.

15. A security device according to claim 14, wherein the extension comprises a relatively thin, elongate plate and a leg depending from the plate in a second direction that defines an angle with the axis defined by the item of merchandise.

16. In combination:
an item of merchandise having at least one removable component; and
a security device for preventing theft of the item of merchandise and the at least one removable component while permitting a potential purchaser to examine the item of merchandise, the security device comprising:
a first sensor attached to the item of merchandise; and
an extension that extends outwardly from the first sensor sufficiently to prevent the at least one removable component from being removed from the item of merchandise.

17. The combination of claim 16, wherein the extension comprises a relatively thin, elongate plate having an outer surface that is adhered to the first sensor and an inner surface that is adhered to the item of merchandise.

18. The combination of claim 16, wherein the extension extends outwardly from the first sensor in a first direction that is generally parallel to an axis defined by the item of merchandise and wherein the extension comprises a plate having a leg depending from the plate in a second direction that defines an angle with the axis defined by the item of merchandise

19. The combination of claim 18, further comprising a second sensor that is attached to the first sensor and to the item of merchandise without interfering with the operation of a moveable component of the item of merchandise.

20. The combination of claim 19, wherein the security device further comprises a base for receiving the first sensor and an alarm circuit disposed within the base, and wherein the first sensor is electrically connected to the alarm circuit and mechanically connected to the base by a first sensor cable and the second sensor is electrically connected to the alarm circuit and mechanically connected to the first sensor by a second sensor cable.
